(19) United States
(12) Patent Application Publication
(10) Pub. No.: US 2006/0193348 A1
(43) Pub. Date: Aug. 31, 2006

(54) Multiplexing device and multiplexed data transmission and reception system

(75) Inventors: Yukiko Unno, Tokyo (JP); Gen Ichimura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/337,661

(22) Filed: Jan. 24, 2006

(30) Foreign Application Priority Data
Feb. 14, 2005 (JP) 2005-036654

(51) Int. Cl. H04J 3/04

(52) U.S. Cl. 370/535

(57) ABSTRACT

A multiplexing device wherein a packet including a one-bit audio signal obtained by subjecting an analog audio signal to a delta sigma modulation process is multiplexed between a plurality of packets including a video signal having a variable bit rate by changing packet interval time information between the plurality of packets including the video signal having the variable bit rate.

### CROSS REFERENCES TO RELATED APPLICATIONS

The present invention contains subject matter related to Japanese Patent Application JP 2005-036654 filed with the Japanese Patent Office on Feb. 14, 2005, the entire contents of which being incorporated herein by reference.

### BACKGROUND OF THE INVENTION

The present invention relates to a multiplexing device that multiplexes audio data and video data, and particularly to a multiplexing device that multiplexes a one-bit audio signal obtained by subjecting an analog audio signal to a delta sigma modulation process or a compressed audio signal obtained by compressing the one-bit audio signal into a video signal having a variable bit rate.

The present invention also relates to a multiplexed data transmission and reception system in which a stream multiplexed by the multiplexing device is transmitted and the transmitted multiplexed stream is decoded.

A delta sigma modulated one-bit audio signal has a very high sampling frequency and a short data word length (for example the sampling frequency is 64 times 44.1 KHz, and the data word length is one bit) as compared with the format of data used in conventional digital audio (for example a sampling frequency of 44.1 KHz, and a data word length of 16 bits). The delta sigma modulated one-bit audio signal has a feature of a wide transmittable frequency band. In addition, even with the one-bit signal, delta sigma modulation makes it possible to secure a high dynamic range in an audio band, which is lower than the 64-times oversampling frequency. Utilizing this feature, the delta sigma modulated one-bit audio signal can be applied to high sound quality recorders and data transmission.

A delta sigma modulator circuit itself is not a particularly new technology. The circuit configuration of the delta sigma modulator circuit is suitable for integration into an IC. In addition, the delta sigma modulator circuit can obtain a high AD conversion accuracy relatively easily. Thus, the delta sigma modulator circuit is often used within a conventional AD converter or the like.

A delta sigma modulated signal can be restored to an analog audio signal by being passed through a simple analog low-pass filter.

For audio waveform coding, there is a method referred to as predictive coding. An audio signal has a correlation not only between samples adjacent to each other but also between points distant from each other. Predictive coding is a method that encodes a difference between a value predicted using the correlation and an actual sample value. The difference has a small variation range as compared with a distribution of actual sample values. In addition, efficient information compression can be performed by performing the coding with a distribution deviation occurring depending on a rate of coincidence of prediction. This principle is useful in a system for compressing and recording a digital audio signal, and is used in a system for compressing and recording a delta sigma modulated one-bit audio signal.

As a method for compressing and recording a one-bit audio signal, there is a lossless coding (lossless compression) technology (refer to U.S. Pat. No. 6,289,306 as Patent Document 1). This technology includes a prediction filter based on the above-described principle of predictive coding and an arithmetic coder. A difference between an input signal and a prediction value is obtained within the prediction filter. The arithmetic coder codes the difference together with a distribution deviation, that is, a distribution probability. Since the distribution probability of a difference is determined by a rate of coincidence of prediction within the prediction filter, the more often the prediction coincides, the higher the probability that can be given to the difference becomes. Then, a difference in an interval is subjected to arithmetic coding within the arithmetic coder using the distribution probability of the difference in the interval, whereby the difference in the interval becomes a compressed code. This technology is currently used as a technology for compressing a one-bit audio signal for Super Audio CD.

For video signal coding, there is an international standard referred to as MPEG (Moving Picture Expert Group). MPEG compresses a video signal by eliminating redundancy in a space domain and a time domain. A discrete cosine transform is used to eliminate redundancy in a space domain. When an image is converted into data in a spatial frequency domain, the data is concentrated on a low-frequency side. Consequently, by assigning fewer bits to data on a high-frequency side, the image can be coded with a smaller total number of bits than before the transform. Inter-frame prediction is used to eliminate redundancy in a time domain. Moving images are formed by a plurality of images referred to as frames. In many cases, a certain frame and an immediately preceding frame as an image 1/30 of a second before the certain frame are similar to each other. Accordingly, based on the immediately preceding frame, extracting and coding only differences between the immediately preceding frame and the present frame leads to a reduction in the number of bits. This is referred to as inter-frame prediction. In MPEG coding, by allotting more data to parts having large differences and allotting less data to parts having small differences, it is possible to further reduce a total amount of data without degradation in image quality. This indicates that a bit rate is variable in a transmission path.

In multiplexing digital signals, it is easy to multiplex a video signal and an audio signal that have a fixed bit rate when using the bit rates of the respective digital signals. It suffices to multiplex the video signal and the audio signal such that the transmitted signal amounts of the respective digital signals are constant at certain time intervals. This method is used in commercially available multiplexing software.

Patent Document 2 (Japanese Patent Laid-open No. Hei 08-172614) describes a configuration using a delta sigma modulator circuit for analog-to-digital conversion of an audio signal in a video-audio multiplex transmitter for multiplexing a video signal and an audio signal for digital transmission. The video-audio multiplex transmitter includes: a memory for writing and storing a video signal having an amount of information with a predetermined rate, and reading video signal data in timing defined by a transmission frame; a delta sigma modulator for converting an analog audio signal into digital data by delta sigma modulation in each clock cycle of a predetermined frequency, and outputting the digital data; and a multiplexing circuit for constructing the transmission frame in a predetermined cycle, multiplexing the video signal data as output of the memory and audio signal data as output of the delta sigma modulator, and outputting a serial signal.

When multiplexing digital signals such for example as a video signal having a variable bit rate and an audio signal, it is necessary to multiplex a transmitting amount of the video signal in a time interval while checking a state of a buffer on a decoder side, so that the process becomes complex.

There is an international standard referred to as MPEG2 Transport Stream (hereinafter abbreviated to MPEG2-TS) as a system for multiplexing a video signal, an audio signal, and other digital signals for addition. An MPEG2-TS digital signal is divided into packets (hereinafter referred to as TS packets) having a fixed length of 188 bytes, and then transmitted. A TS packet includes items showing a cyclic counter, a bit error indicator, and the like. The TS packet is assumed to be applied to an environment where data transmission errors occur, such as broadcasting, a communication network or the like.

An MPEG2-TS is used on a communication channel having a fixed transmission rate. Examples where MPEG2-TS is put to practical use include SKY PerfecTV, DirecTV, BS digital broadcasting, and the like. There is a method of recording packet interval time information indicating time intervals between fixed-length packets as well as packets having the fixed length of 188 bytes when recording an MPEG2-TS transmitted by a communication channel of SKY PerfecTV, DirecTV, BS digital broadcasting, and the like onto digital media. This indicates that by separately recording an interval from a packet to a next packet as time information, reproduction can be performed in the same timing as in recording. In BS digital broadcasting, for example, only necessary packets for a program desired to be recorded are recorded, while unnecessary packets are not recorded, and packet interval time information as described above is recorded, whereby a total amount of recordings is reduced. Such an MPEG2-TS is referred to as a partial TS, and is used also in an ARIB (Association of Radio Industries and Businesses) standard.

When receiving TS packets, an MPEG2-TS decoder first divides the TS packets into elements such as video, audio, and the like, and each of the elements is buffered. Then, signals buffered in respective decoding systems are decoded and reproduced at specified decoding and reproduction times.

### SUMMARY OF THE INVENTION

Applications for transmitting the partial TS should also need a multiplexing device that multiplexes a one-bit audio signal having a fixed bit rate or a signal obtained by compressing the one-bit audio signal by compression techniques without changing the image quality and output time of a video signal having a variable bit rate within a digital signal multiplexing system.

The present invention has been made in view of the above actual situation. It is desirable to provide a multiplexing device that can multiplex a one-bit audio signal having a fixed bit rate or a signal obtained by compressing the one-bit audio signal by compression techniques, and provide a multiplexed data transmission and reception system in which a stream multiplexed by the multiplexing device is transmitted to a receiving side, and then decoded and reproduced on the receiving side.

The present invention provides a multiplexing device, wherein a packet including a one-bit audio signal obtained by subjecting an analog audio signal to a delta sigma modulation process is multiplexed between a plurality of packets including a video signal having a variable bit rate by changing packet interval time information between the plurality of packets including the video signal having the variable bit rate.

The present invention further provides a multiplexing device for multiplexing audio data between video signal packets to be transmitted, the multiplexing device including: interval controlling means for referring to packet interval time information between a plurality of packets including a video signal having a variable bit rate, and performing control to embed a packet including a one-bit audio signal obtained by subjecting an analog audio signal to a delta sigma modulation process in a packet interval selected with a predetermined time interval as a reference; embedding means for embedding the packet including the one-bit audio signal between a plurality of packets including the video signal under control of the interval controlling means; and rewriting means for rewriting packet interval time information after the embedding means embeds the packet between the plurality of packets including the video signal.

The present invention further provides a multiplexed data transmission and reception system in which a video signal to be transmitted and an audio signal are multiplexed and transmitted, the multiplexed data transmission and reception system including: a multiplexing device for multiplexing a packet including a one-bit audio signal obtained by subjecting an analog audio signal to a delta sigma modulation process between a plurality of packets including a video signal having a variable bit rate by changing packet interval time information between the plurality of packets including the video signal having the variable bit rate; and a decoding device for receiving multiplexed data from the multiplexing device, and decoding the multiplexed data using a buffer memory.

### BRIEF DESCRIPTION OF THE DRAWINGS

FIG. 1 is a block diagram of a multiplexed data transmission and reception system including a partial TS signal editor according to a first embodiment;

FIG. 2 is a block diagram of a digital broadcasting receiver;

FIG. 3 is a diagram showing a configuration of a delta sigma modulator;

FIG. 4 is a diagram of assistance in explaining the processing of a one-bit quantizer;

FIG. 5 is a circuit diagram of a fifth-order delta sigma modulator;

FIG. 6 is a conceptual diagram of a packet embedding process in the partial TS signal editor;

FIG. 7 is a functional block diagram of the partial TS signal editor;

FIG. 8 is a flowchart representing a process procedure in the partial TS signal editor;

FIGS. 9A, 9B, 9C, and 9D are diagrams representing the concept of embedding control;

FIG. 10 is a first-half part of a flowchart representing a process procedure indicating how packets Dn including a DSD signal are evenly embedded within a unit time C;

FIG. 11 is a second-half part of the flowchart representing the process procedure indicating how the packets Dn including the DSD signal are evenly embedded within the unit time C;

FIG. 12 is a block diagram showing a configuration of a decoder that is present within the digital video-audio player and reproduces a new partial TS signal;

FIG. 13 is a block diagram of a multiplexed data transmission and reception system including a partial TS signal editor according to a second embodiment;

FIG. 14 is a block diagram of a DST compressor; and

FIG. 15 is a conceptual diagram of a distributing process at a time of embedding packets in the partial TS signal editor according to the second embodiment.

### DETAILED DESCRIPTION OF PREFERRED EMBODIMENTS

Preferred embodiments of the present invention will hereinafter be described with reference to the drawings. A first embodiment is a partial TS signal editor as a concrete example of a multiplexing device that multiplexes a partial TS signal including an HD-quality video signal and a 2-ch (stereo) one-bit audio signal.

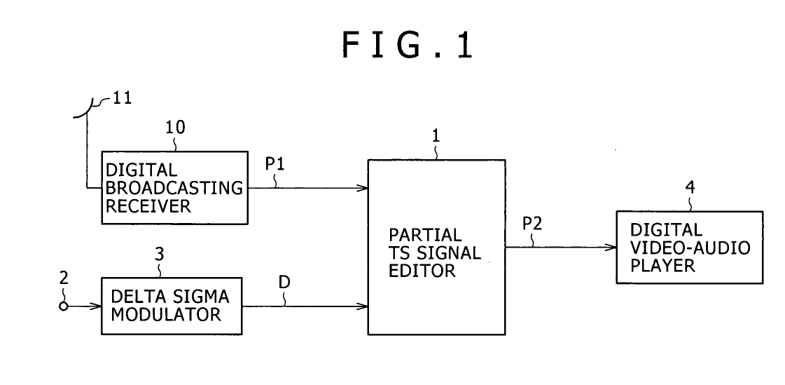

FIG. 1 shows a multiplexed data transmission and reception system including the partial TS signal editor 1 according to the first embodiment and a digital video-audio player 4 that receives multiplexed data as edit output transmitted from the partial TS signal editor 1 and reproduces an HD video signal and a one-bit audio signal.

The partial TS signal editor 1 receives a partial TS signal P1 including a video signal having a variable bit rate from a receiver for digital broadcasting (Digital Integrated Receiver Decoder: DIRD). The partial TS signal editor 1 also receives a one-bit audio signal D obtained by subjecting an analog audio signal input from an input terminal to a delta sigma modulation process in a delta sigma modulator. Then, the partial TS signal editor 1 embeds a TS packet including the one-bit audio signal D in the original partial TS signal P1 by changing packet interval time information on a packet interval between a plurality of packets including the video signal having the variable bit rate. The partial TS signal editor 1 outputs resulting new partial TS packets P2 to the digital video-audio player 4.

The digital broadcasting receiver 10 receives so-called multi-channel broadcast such as digital CS (Communication Satellite) broadcast, digital BS (Broadcasting Satellite) broadcast and the like. Specifically, the digital broadcasting receiver 10 receives a plurality of transport streams transmitted from a plurality of respective transponders and received via an antenna. The digital broadcasting receiver extracts one transport stream transmitted from one given transponder from the plurality of received transport streams. From the transport stream, the digital broadcasting receiver 10 extracts transport stream packets (TS) storing an elementary stream (a video signal or an audio signal) constituting a program specified (selected) by a predetermined operation by a user as well as Program Specific Information (PSI) and the like. The digital broadcasting receiver further generates a partial TS signal as a transport stream in which only the selected program is multiplexed on the basis of the extracted TS packets, the extracted PSI and the like.

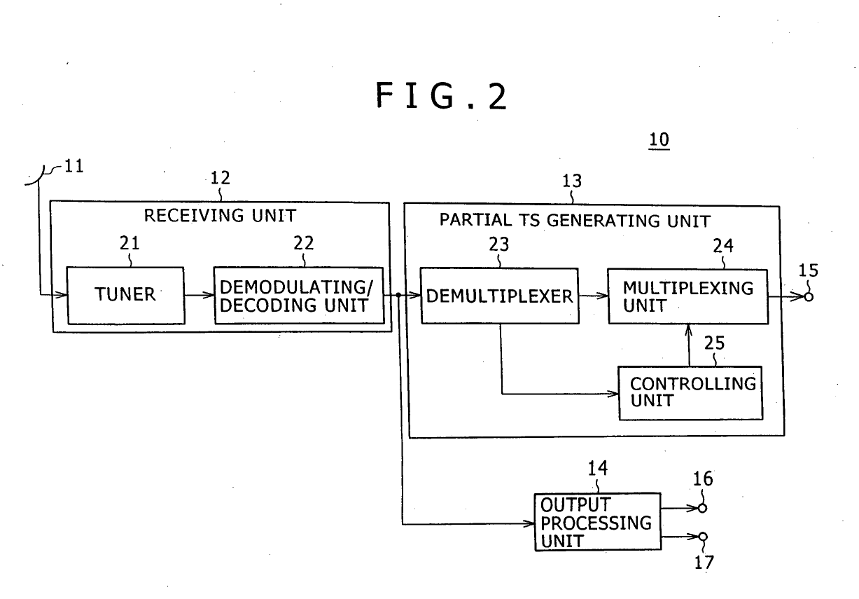

FIG. 2 is a diagram showing a configuration of the digital broadcasting receiver 10. The digital broadcasting receiver 10 in FIG. 2 includes an antenna 11, a receiving unit 12, a partial TS generating unit 13, and an output processing unit 14. The receiving unit 12 includes a tuner 21 and a demodulating/decoding unit 22. The tuner 21 reads one transport stream in which a program selected by a predetermined operation by a user is multiplexed from a plurality of transponder streams received via the antenna 11. The tuner 21 outputs the transport stream to the demodulating/decoding unit 22. The demodulating/decoding unit 22 demodulates and decodes the transport stream input from the tuner 21. The demodulating/decoding unit 22 outputs the demodulated and decoded signal to a demultiplexer 23 in the partial TS generating unit 13. When the signal is to be output (displayed) via a television, the demodulating/decoding unit 22 outputs the signal to the output processing unit 14.

The demultiplexer 23 in the partial TS generating unit 13 separates the transport stream input from the demodulating/decoding unit 22 in the receiving unit 12. The demultiplexer 23 extracts PES (Packetized Elementary Stream) packets including an elementary stream constituting one program selected by the predetermined operation by the user from the separated transport stream. The demultiplexer 23 outputs the PES packets to a multiplexing unit 24. The demultiplexer 23 also extracts PSI or the like indicating program specification information from the separated transport stream. The demultiplexer 23 outputs the PSI or the like to a controlling unit 25.

Referring to the PSI or the like, the controlling unit 25 generates packet interval time information indicating a time interval between 188-byte fixed length packets, for example, as elementary packets of one partial TS in which only the one selected program is multiplexed. The controlling unit 25 supplies the packet interval time information to the multiplexing unit 24. This packet interval time information is a representation of an interval from a certain packet to a next packet as time information. The packet interval time information recorded at a time of processing for transmission enables reproduction in the same timing as that before the transmission on a reproducing side.

The multiplexing unit 24 generates one partial TS signal P1 in which only the one selected program is multiplexed by multiplexing the PES packets input from the demultiplexer 23 and the PSI and the packet interval time information from the controlling unit 25. The multiplexing unit 24 outputs the partial TS signal P1 from an output terminal 15 to an IEEE 1394 bus connected to an IEEE 1394 interface (I/F), for example. The IEEE 1394 bus is connected to the partial TS signal editor 1 so that the partial TS signal P1 is supplied to the partial TS signal editor 1.

The output processing unit 14 separates the transport stream input from the demodulating/decoding unit 22 in the receiving unit 12 to extract audio data and video data. The output processing unit 14 decodes the audio data and the video data by respective decoders. The output processing unit 14 outputs the results from output terminals 16 and 17 to a television receiver or the like not shown in the figure.

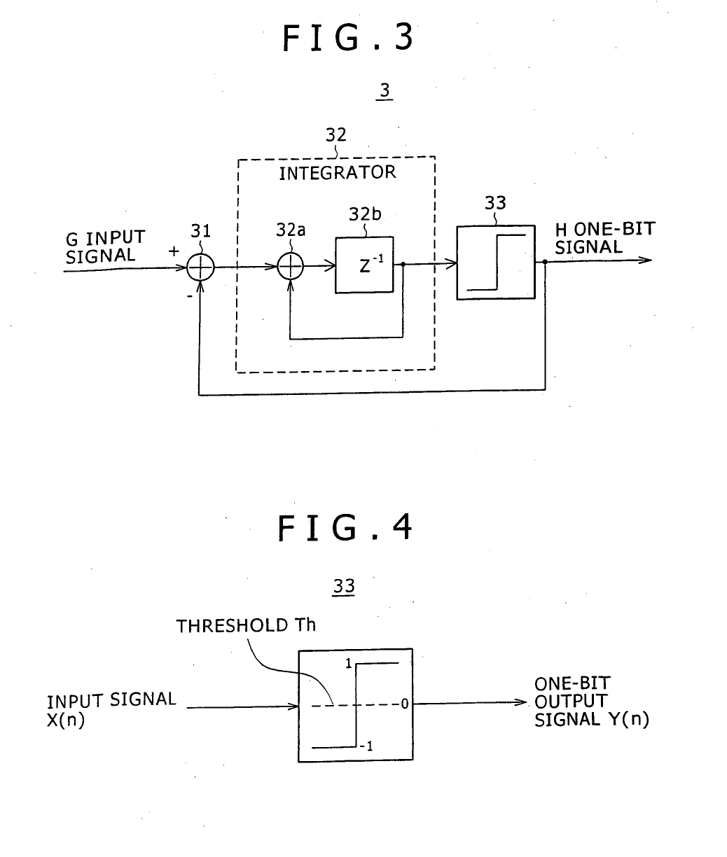

FIG. 3 shows a configuration of a delta sigma modulator 3 for generating a high-quality one-bit audio signal defined as DSD (Direct Stream Digital). The delta sigma modulator 3 is formed by a combination of one integrator 32, one one-bit quantizer 33, and a feedback system for quantization output of the one-bit quantizer 33. Specifically, the delta sigma modulator 3 includes: an adder 31 having a positive input terminal supplied with an input signal G, and having a negative input terminal supplied with a feedback output to be described later; the integrator 32 for subjecting the addition output of the adder 31 to an integrating process; the one-bit quantizer 33 for quantizing the integration output of the integrator 32 into a one-bit digital signal in each sampling cycle. The quantization output H of the one-bit quantizer 33 is fed back to the adder 31 with a negative sign attached to the quantization output H, and then added to the input signal G (in effect subtracted from the input signal G). In addition, the one-bit digital signal is output as quantization output from the one-bit quantizer 33 to the outside. The integrator 32 includes an adder 32a and a delay device 32b.

As shown in FIG. 4, the one-bit quantizer 33 generates a one-bit output signal Y(n) by subjecting an input signal X(n) to a quantizing process referring to a threshold value Th that is not varied with time and is zero at all times. That is, the one-bit quantizer 33 quantizes the input signal X(n) by determining two levels not lower than zero and lower than zero with zero as a threshold.

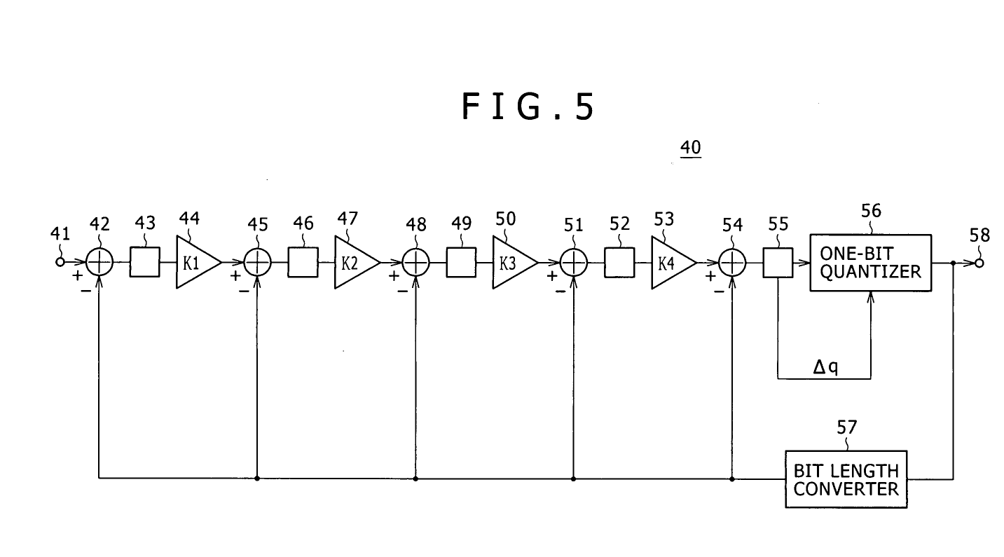

FIG. 5 shows a configuration of a delta sigma modulator 40 having a plurality of integrators. The delta sigma modulator 40 shown in FIG. 5 is a fifth-order delta sigma modulator having five integrators 43, 46, 49, 52, and 55. The delta sigma modulator 40 also includes: adders 42, 45, 48, 51, and 54 in front of the five integrators 43, 46, 49, 52, and 55, for outputting a multi-bit digital signal to the respective integrators; four attenuators 44, 47, 50, and 53 connected to the rear of the first to fourth integrators 43, 46, 49, and 52 of the five integrators; a one-bit quantizer 56 connected to the rear of the fifth integrator 55, the one-bit quantizer 56 being similar to the one-bit quantizer 33; and a bit length converter 57 for converting the bit length of a one-bit digital signal from the one-bit quantizer 56 to a multi-bit length, and supplying the multi-bit digital signal to the adders 42, 45, 48, 51, and 54 for supplying an input to the five integrators 43, 46, 49, 52, and 55.

The first integrator 43 integrates an input signal supplied via an input terminal 41 and the adder 42. For this, the first integrator 43 employs a configuration in which an output from an adder similar to the adder 32a shown in FIG. 3 is delayed by a delay device similar to the delay device 32b and then fed back to the adder. The second to fifth integrators 46, 49, 52, and 55 have a similar configuration.

An integration output from the fifth integrator 55 is supplied to the one-bit quantizer 56. The one-bit quantizer 56 sets Δq as a threshold level Th referred to in a quantizing process as follows. The setting is made on the basis of an amplitude obtained in the integrator in the last stage. Specifically, a value SαDend obtained by multiplying a maximum value Dend of amplitude of a signal generated in the integrator in the last stage by a certain constant Sα is set as an optimum variable threshold level Δq. That is, Δq is calculated as Δq=SαDend. This calculating method can set a result of multiplication by a uniquely determined constant as an optimum variable threshold level in any delta-sigma modulation configuration. Thus, Δq is calculated on the basis of the amplitude Dend of the signal within the fifth integrator 55 in the last stage.

Thus, in a quantizing process performed on the integration output of the fifth integrator 55 by the one-bit quantizer 56, the reference threshold level can be appropriately varied on a random basis with respect to a time axis, so that distortion dependent on the input signal does not occur. The one-bit output signal is output from an output terminal 58, and supplied to the bit length converter 57.

The bit length converter 57 converts the one-bit signal from the one-bit quantizer 56 into a multi-bit digital signal, and feeds back the multi-bit digital signal to the adders 42, 45, 48, 51, and 54 with a negative sign attached to the multi-bit digital signal. Thus, the adders 42, 45, 48, 51, and 54 subtract the output signal of the bit length converter 57 from signals supplied from the input terminal 41 and the integrators 43, 46, 49, and 52 in preceding stages via the attenuators 44, 47, 50, and 53.

The attenuators 44, 47, 50, and 53 attenuate the respective integration outputs of the integrators 43, 46, 49, and 52 using coefficients K1, K2, K3, and K4. The attenuators 44, 47, 50, and 53 supply the results to the adders 45, 48, 51, and 54.

Thus, the delta sigma modulator 40 can appropriately vary the threshold level referred to in the quantizing process in the one-bit quantizer 56 on a random basis with respect to a time axis, so that distortion dependent on the input signal does not occur.

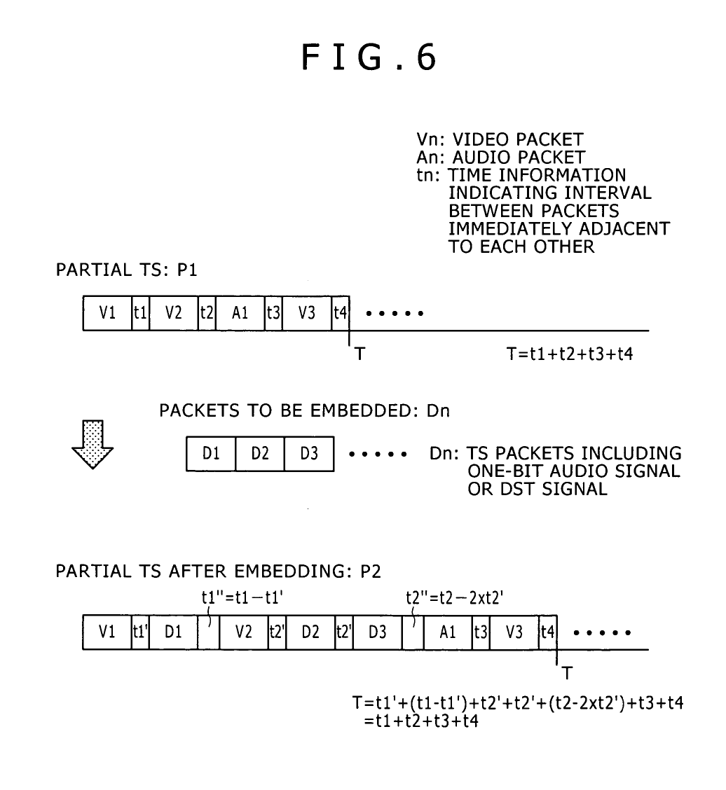

The concept of a packet embedding process in the partial TS signal editor 1 will next be described with reference to FIG. 6. The partial TS signal editor 1 embeds a TS packet Dn including a one-bit audio signal in a partial TS signal P1 serving as a basis, and thereby obtains a new partial TS signal P2.

The partial TS signal P1 serving as a basis is generated by the partial TS generating unit 13 in the digital broadcasting receiver 10 shown in FIG. 2. The partial TS signal P1 includes video packets denoted by Vn and audio packets denoted by An, the video packets and the audio packets constituting one program. Each packet has a fixed length of 188 bytes. Packet interval time information tn as time information indicating an interval between packets immediately adjacent to each other is written as four-byte information, for example, between the packets. That is, four-byte packet interval time information tn is a representation of an interval from a certain packet to a next packet as time information.

For example, packet interval time information t1 is written between a video packet V1 and a video packet V2. This information indicates that a packet interval from a start of transmission of the video packet V1 to a start of transmission of the next video packet V2 is t1. Packet interval time information t2 written between the video packet V2 and an audio packet A1 similarly indicates that a packet interval from a start of transmission of the video packet V2 to a start of transmission of the next audio packet A1 is t2.

Packets Dn to be embedded in the original partial TS signal P1 and including a one-bit audio signal also have a fixed length of 188 bytes. In the example of FIG. 6, packets D1, D2, and D3 are shown as packets to be embedded. The one-bit audio signal supplied from the delta sigma modulator 3 has been converted into packets of the 188-byte fixed length by a packetizing unit not shown in the figure.

In FIG. 6, when referring to the packet interval time information t1 between the video packet V1 and the video packet V2, it is determined that the packet D1 can be embedded between these packets, packet interval time information t1′ is set such that t1>t1′. This packet interval time information t1′ is set as information on an interval between the video packet V1 and the packet D1 after being embedded, and is written between these packets.

At this time, a packet interval in which the packet D1 can be embedded is selected referring to packet interval time information between a plurality of packets on a basis of a predetermined time interval. For example, with a minimum packet interval as a reference, a packet interval as a time interval greater than the minimum packet interval is selected.

Next, packet interval time information between the packet D1 and the video packet V2 is set as t1″=t1−t1′. The packet interval time information t1″ is determined so as to maintain the interval t1 between the video packet V1 and the video packet V2 in the original partial TS signal P1. At the time of determining the packet interval time information t1′, when the packet interval time information t1′ is set as a value obtained by dividing the packet interval time information t1 by (the number of embedded packets+1), that is, t1/2=t1′ so that values of the adjacent pieces of packet interval time information t1′ and t1″ are equated as much as possible, a difference between t1′ and t1″ (t1″=t1−t1′) is reduced, and therefore an abrupt bit rate change does not occur.

Similarly, when referring to the packet interval time information t2 between the video packet V2 and the audio packet A1, it is determined that the packet D2 and the packet D3 can be embedded between these packets, pieces of packet interval time information t2′ and t2″ are set such that t2=t2′+t2′+t2″ and t2″=(t2−2×t2′). A packet interval between the video packet V2 and the packet D2 is set as t2′; an interval between the packet D2 and the packet D3 is set as t2′; and an interval between the packet D3 and the audio packet A1 is set as t2″. In this case, t2/3=t2′.

While the packets Dn are thus embedded and thereby packet interval time information is rewritten, a total elapsed time T is unchanged.

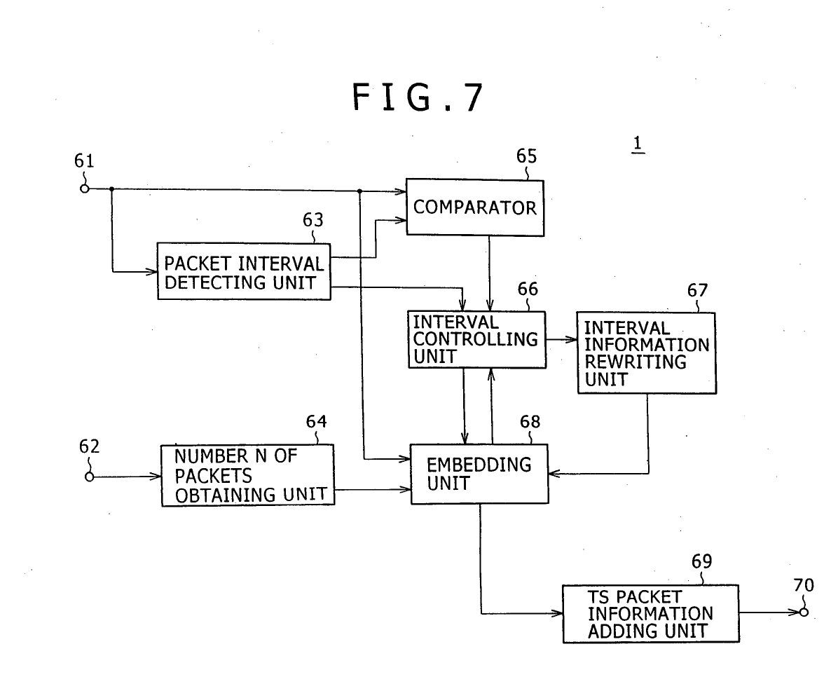

Details of the configuration and operation of the partial TS signal editor 1 will next be described with reference to FIGS. 7 to 11.

FIG. 7 is a functional block diagram of the partial TS signal editor 1. The partial TS signal editor 1 includes: a packet interval detecting unit 63 for detecting a minimum packet interval MIN of the original partial TS signal P1; a comparator 65 for comparing each piece of packet interval time information of the original partial TS signal with the minimum packet interval detected by the packet interval detecting unit 63, and outputting detection information indicating which pieces of packet interval time information are greater than the minimum packet interval time information MIN; and an interval controlling unit 66 for controlling the packet embedding operation of an embedding unit 68 to be described later on the basis of the detection information from the comparator 65.

The partial TS signal editor 1 further includes: the embedding unit 68 for embedding the packets Dn in the original partial TS signal P1 under control of the interval controlling unit 66; an interval information rewriting unit 67 for rewriting the packet interval time information in the embedding unit 68 on the basis of interval information from the interval controlling unit 66; a number N of packets obtaining unit 64 for obtaining the number N of packets including a one-bit audio signal required to be multiplexed within a unit time C; and a TS packet information adding unit 69 for adding information on TS packets including the DSD signal to a TS packet including information necessary for transmission of a partial TS.

Thus, in the partial TS signal editor 1, the comparator 65 compares packet interval time information between a plurality of packets including a video signal having a variable bit rate with the minimum packet interval time information, and the interval controlling unit 66 performs control on the basis of a result of the comparison to embed a packet Dn including the one-bit audio signal where packet interval time information is greater than the minimum packet interval time information.

The embedding unit 68 embeds the packet between a plurality of packets including the video signal under control of the interval controlling unit 66, and the interval information rewriting unit 67 rewrites the packet interval time information after the embedding unit 68 embeds the packet between the plurality of packets including the video signal.

As will be described later, the embedding unit 68 embeds the packet Dn according to the number of packets including the one-bit audio signal to be embedded between a plurality of packets (partial TS signal P1) including the video signal within the unit time C.

The partial TS signal editor 1 is supplied via an input terminal 61 with a partial TS signal generated by the partial TS generating unit 13 in the digital broadcasting receiver 10 and transmitted via the IEEE 1394 bus, for example. A one-bit audio signal supplied from the delta sigma modulator 3 is input via an input terminal 62.

The partial TS signal is supplied to the packet interval detecting unit 63 and the comparator 65. The packet interval detecting unit 63 detects a minimum packet interval MIN of the original partial TS signal P1, and supplies the minimum packet interval MIN to the comparator 65. The comparator 65 notifies the interval controlling unit 66 of detection information indicating which of the pieces of packet interval time information of the original partial TS signal are greater than the minimum packet interval time information MIN. The interval controlling unit 66 supplies the embedding unit 68 with an embedding control signal to embed a packet D in a greater interval on the basis of the detection information supplied from the comparator 65 and equate TS packet intervals.

The embedding unit 68 embeds packets Dn including the one-bit audio signal in the original partial TS signal P1 on the basis of the embedding control signal supplied from the interval controlling unit 66. The packets Dn are supplied as a number N of packets in a unit time C from the number N of packets obtaining unit 64. The number N of packets obtaining unit 64 is a block for obtaining the number N of packets Dn including the one-bit audio signal supplied from the input terminal 62, the number N being required to be multiplexed within a unit time C. The concept of operation of the number N of packets obtaining unit 64 will be described later.

When the embedding unit 68 embeds the packets Dn including the one-bit audio signal in the original partial TS signal P1 on the basis of the embedding control signal supplied from the interval controlling unit 66, the interval information rewriting unit 67 rewrites new packet interval time information tn between packets. Thus, the interval information rewriting unit 67 rewrites the packet interval time information in the embedding unit 68 on the basis of interval information from the interval controlling unit 66.

Partial TS packets after the embedding of the packets Dn, the partial TS packets being output from the embedding unit 68, are supplied to the TS packet information adding unit 69. The TS packet information adding unit 69 adds information on the TS packets including the DSD signal to a TS packet including information necessary for transmission of a partial TS. Resulting partial TS packets are transmitted from an output terminal 70. The addition of information on the TS packets including the DSD signal to a TS packet including information necessary for transmission of a partial TS is performed by a method proposed by the present applicant in Japanese Patent Application No. 2004-174763.

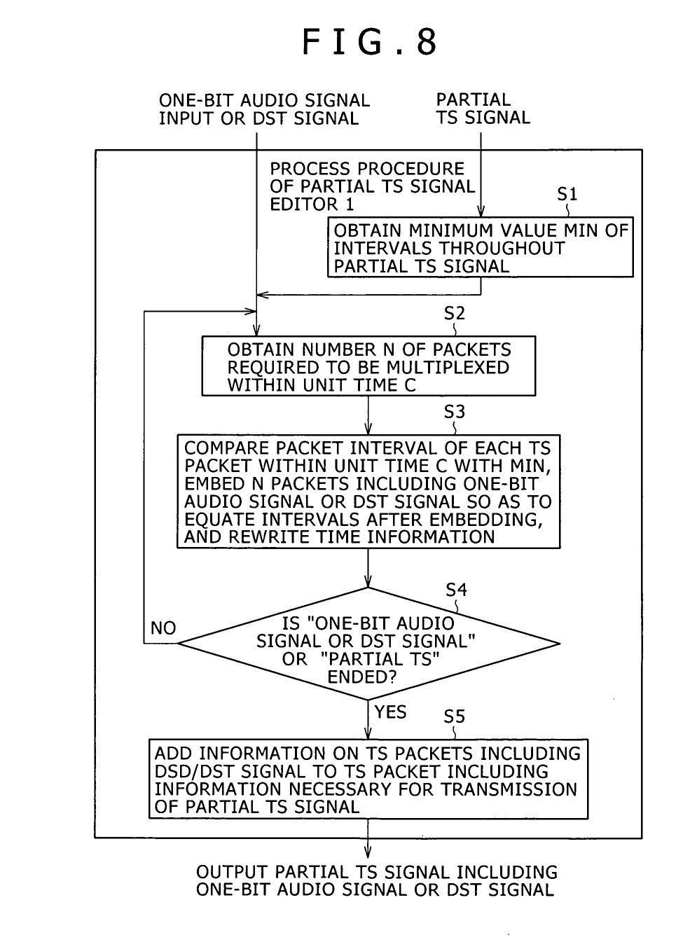

FIG. 8 is a flowchart representing a process procedure of the partial TS signal editor 1 formed as described above. In first step S1, the packet interval detecting unit 63 detects a minimum packet interval MIN of an original partial TS signal P1. The packet interval detecting unit 63 supplies the minimum packet interval MIN to the comparator 65. In next step S2, the number N of packets obtaining unit 64 determines the number N of packets to be multiplexed in a unit time C of TS packets Dn including a one-bit audio signal.

The number N of packets to be multiplexed refers to a number of packets that enable uninterrupted reproduction when N packets are multiplexed in a certain unit time C. A DSD (Direct Stream Digital) signal has a fixed rate of 75 Hz for one frame. That is, a DSD signal has the fixed rate with 1/75 [s] for one frame. In the case of a two-channel DSD signal, a DSD signal for one frame is stored in 52 TS packets. Hence, the unit time C is a time for achieving uninterrupted transmission of a number N of packets (=52 TS packets) forming one frame, and can be set to 1/75 [s], for example.

In next step S3, the comparator 65 compares a packet interval tn between TS packets within the unit time C with the minimum value MIN detected by the packet interval detecting unit 63, the interval controlling unit 66 generates an embedding control signal to equate intervals after embedding, and then supplies the embedding control signal to the embedding unit 68, the embedding unit 68 embeds a packet Dn including the one-bit audio signal in the original partial TS signal P1, and the interval information rewriting unit 67 rewrites packet interval time information.

In this step S3, when the minimum packet interval MIN is one second and packet intervals within the unit time C are one second, two seconds, one second, and four seconds in this order, for example, a packet is embedded in the intervals of two seconds and four seconds, and intervals after the embedding of the packets is set not less than the minimum packet interval MIN. When packets embedded in the longer intervals are short in number, packets are inserted into interval parts having smaller differences from the minimum packet interval MIN. In this case, the intervals are rewritten as values obtained by dividing the original intervals into two equal parts in order to avoid an abrupt change in a bit rate. For example, when a packet is embedded in a one-second part, intervals after the embedding of the packet are set to 0.5 seconds.

In step S4, whether the packets Dn including the one-bit audio signal or the partial TS signal P1 is ended is determined. When the packets Dn including the one-bit audio signal or the partial TS signal P1 is ended, the process proceeds to step S5, where information on the TS packets including the one-bit audio signal is added to a TS packet including information necessary for transmission of a partial TS signal.

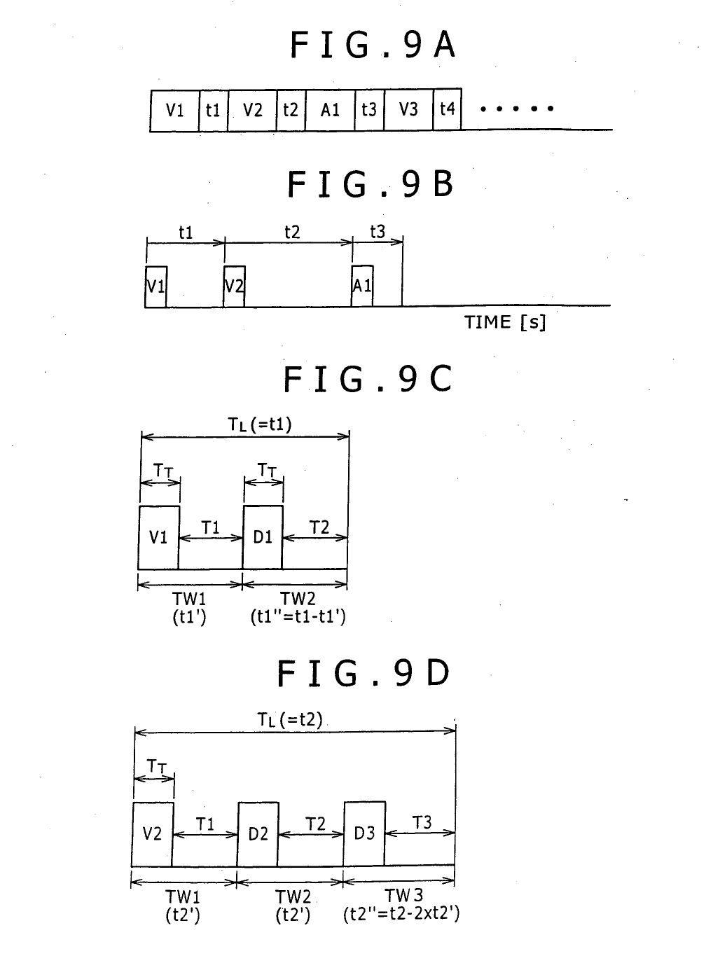

FIGS. 9A, 9B, 9C, and 9D represent the concept of embedding control on the embedding unit 68 by the interval controlling unit 66. Each piece of packet interval time information of a partial TS signal P1 shown in FIG. 9A is as shown in FIG. 9B on a time axis. Suppose in this case that t3 is a minimum value MIN. Suppose that one packet D1 is embedded in a packet interval time t1, which is longer than the minimum value MIN and that two packets D2 and D3 are embedded in a packet interval time t2.

FIG. 9C represents the concept of a process performed in the interval controlling unit 66 when one packet D1 is embedded in the packet interval t1. In FIG. 9C, TT denotes the transmission time of one packet. TL denotes packet interval time information. T1 denotes a time from an end of transmission of a packet V1 to a start of transmission of a packet D1. T2 is a remaining time of the packet interval time information TL after an end of the transmission of the packet D1. TW1 denotes a time from the transmission of the video packet V1 to the transmission of the next packet D1, that is, the packet interval time information of the video packet V1 after the embedding of the packet D1. TW2 denotes a time from the transmission of the packet D1 to an end of the packet interval TL, and is the packet interval time information of the packet D1 after the embedding of the packet D1.

When one packet D1 is embedded at the time of transmitting the video packet V1 at the packet interval TL, the interval controlling unit 66 sets a position after passage of the time TW1 from the transmission of the video packet V1 to the transmission of the next packet D1 as a position at which the packet D1 is embedded. This time TW1 is equal to or more than the transmission time TT of 188 bytes. It is desirable that the time TW1 be set equal to or less than a value obtained by dividing the packet interval TL by the number (n+1) of packets present within the packet interval TL after embedding.

Making generalization, when n packets including the one-bit audio signal are embedded at a time of transmission of one packet including the video signal in arbitrary packet interval time information TL, the interval controlling unit 66 sets a time TW1 through a start of transmission of a first packet of the n packets equal to or more than a time for transmitting the one packet including the video signal and equal to or less than TL/(n+1) obtained by dividing the arbitrary packet interval time information TL by (n+1).

When this is expressed by an equation, TT≦TW1≦TL/(n+1). Hence, ideally, it is desirable that when one packet D1 is to be embedded, the packet interval TW1 be TL/2.

FIG. 9D represents principles of a process performed in the interval controlling unit 66 when the two packets D2 and D3 are embedded in the packet interval t2. Specifically, when the two packets D2 and D3 are embedded at the time of transmitting a video packet V2 at a packet interval TL, a position at which the packet D2 is embedded is a position after passage of a time TW1 from the transmission of the video packet V2 to the transmission of the next packet D2. This time TW1 is equal to or more than the transmission time TT of 188 bytes. The time TW1 is set equal to or less than a value obtained by dividing the packet interval TL by the number (2+1) of packets present within the packet interval TL after the embedding of the two packets D2 and D3.

When this is expressed by an equation, TT≦TW1≦TL/3.

A position at which the packet D3 is embedded is a position after passage of a time TW2 from the transmission of the packet D2 to the transmission of the next packet D3. The time TW2 is equal to or more than the transmission time TT of 188 bytes. The time TW2 is set equal to or less than a value obtained by dividing the packet interval TL by the number (2+1) of packets present within the packet interval TL after the embedding of the two packets D2 and D3.

Hence, ideally, it is desirable that when the two packets D2 and D3 are to be embedded, packet intervals be TW1=TW2=TW3=TL/3.

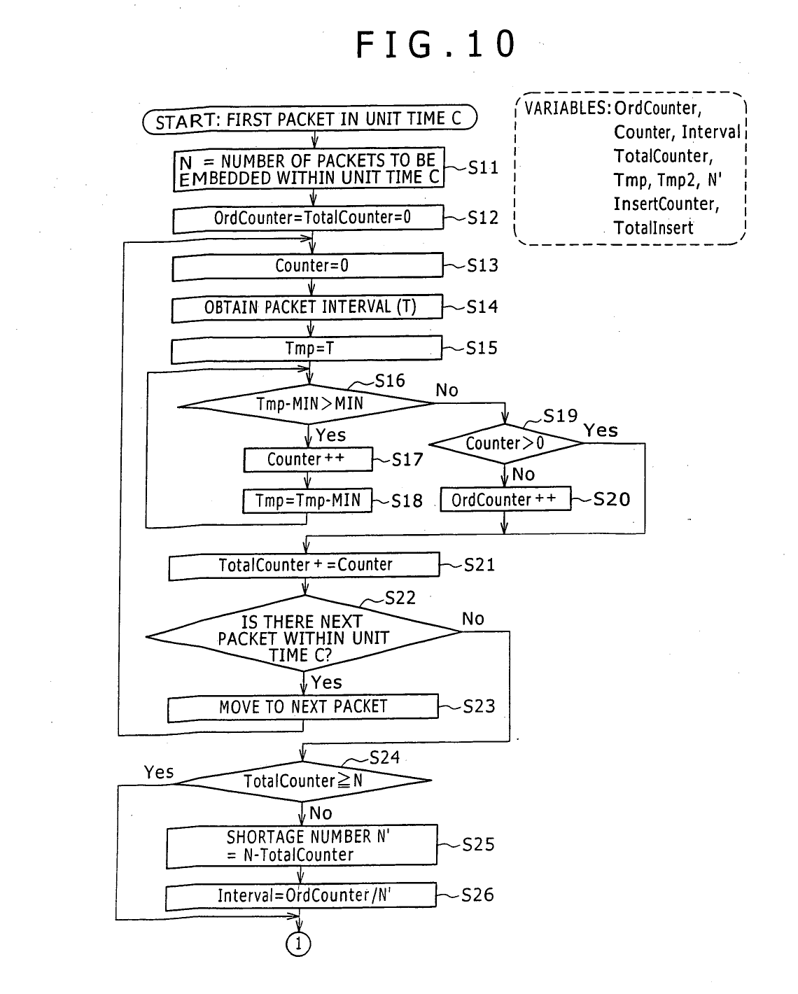

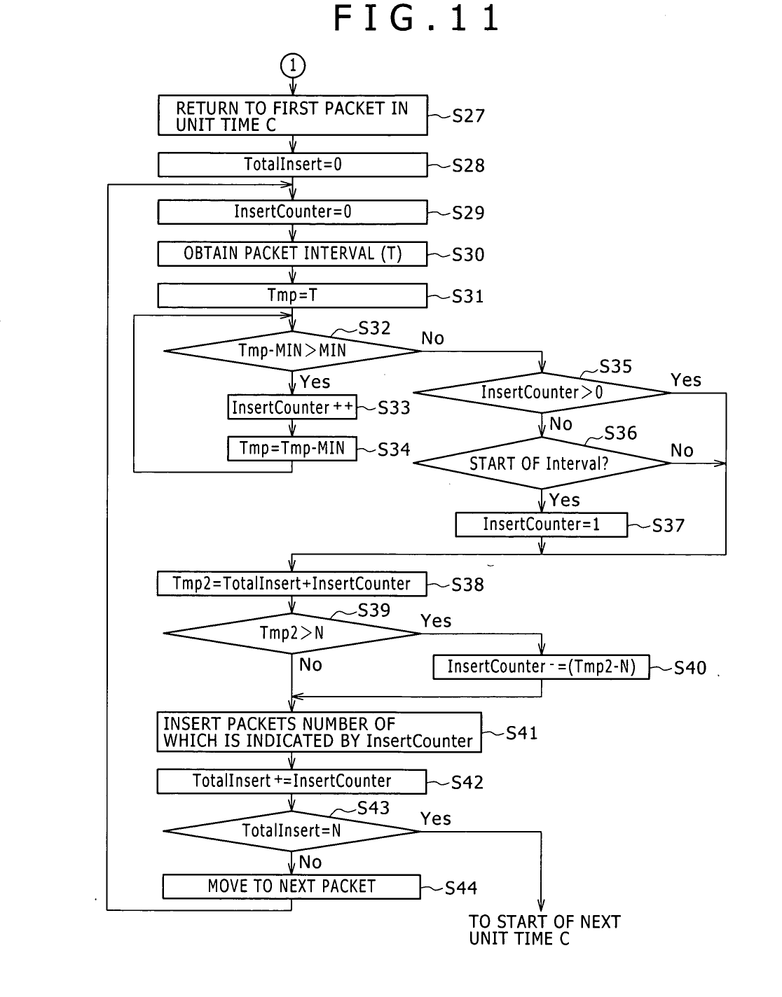

FIG. 10 and FIG. 11 represent a process procedure based on an algorithm for determining how the partial TS signal editor 1 evenly embeds packets Dn including a DSD signal (one-bit audio signal) within a unit time C. Thereby description will be made of details of the process procedure of steps S1 to S3 in FIG. 8, particularly step S3. Incidentally, description in the following will be made supposing that a CPU (Central Processing Unit) constitutes each functional block of the partial TS signal editor 1 shown in FIG. 7 by executing a multiplexing program.

As variables, there are an ordinal count value OrdCounter obtained by counting in order the number of packet intervals T in which a packet Dn cannot be embedded, a present count value Counter indicating a present count value of packets Dn that can be embedded, an interval Interval indicating a new packet interval for evenly embedding a number (shortage number) N′ that cannot be embedded among a number n of packets Dn to be embedded in a unit time C in packet intervals where a packet cannot be embedded, a total count value TotalCounter, a temporary value Tmp, a temporary value Tmp2, a packet shortage number N′, an insertion count value InsertCounter indicating the present number of inserted packets Dn, and a total insertion count TotalInsert indicating a total number of inserted packets Dn. The CPU performs an operation in each step using these variables to evenly embed packets Dn within a unit time C.

First, at a start, a pointer is set at a first packet in a unit time C. Then, in step S11, the number N of packets to be embedded within the unit time C is set. In step S12, the ordinal count value OrdCounter and the total count value TotalCounter as variables are set to zero. In step S13, the present count value Counter is set to zero. That is, the CPU obtains the number of packets to be embedded within the unit time C by functioning as the number N of packets obtaining unit 64 in step S11. Then, in step S12 and step S13, the CPU initializes the variables OrdCounter, TotalCounter, and Counter.

In step S14, a packet interval (T) is obtained. In step S15, the obtained packet interval T is set as the variable Tmp. In step S16, the CPU functions as the comparator 65 to determine whether Tmp−MIN is greater than MIN already detected by functioning in advance as the packet interval detecting unit 63. That is, in steps S14 to S16, the CPU functions as the comparator 65 to compare the packet interval T of each TS packet within the unit time C with the minimum value MIN.

The CPU thereafter functions as the interval controlling unit 66. When a result of the comparison in step S16 indicates that Tmp−MIN is greater than MIN, the process proceeds to step S17, where the variable Counter is incremented because one packet Dn can be embedded. In step S18, the packet interval after the variable Counter is incremented because one packet Dn can be embedded is changed to Tmp−MIN, and is then set as Tmp. The process returns to step S16.

When the result of the comparison in step S16 indicates that Tmp−MIN is not greater than MIN, the process proceeds to step S19, where the CPU determines whether the variable Counter as the present count value is greater than zero. Determining that the variable Counter as the present count value is greater than zero means that packets Dn corresponding in number to the variable can be embedded. Thus, the process proceeds to step S21, where the present count value Counter is added to the total count value TotalCounter.

When the CPU functions as the interval controlling unit 66 and determines in step S19 that the present count value Counter is not greater than zero, it indicates that packets Dn cannot be embedded in this packet interval T. In step S20, the ordinal count value OrdCounter obtained by counting in order the number of packet intervals T in which a packet Dn cannot be embedded is incremented. After the ordinal count value OrdCounter is incremented in step S20, the process proceeds to step S21.

After the present count value Counter is added to the total count value TotalCounter in step S21, the process proceeds to step S22 to determine whether there is a next packet within the unit time C. When there is a next packet within the unit time C, the pointer is moved to the next packet in step S23. The process returns to step S13. The process of steps S13 to S21 is then repeated for the next packet.

Determining in step S22 that there is no next packet within the unit time C means that a process for a last packet within the unit time C is completed. The process therefore proceeds to step S24 to determine whether the total count value TotalCounter is equal to or higher than the number N of packets to be embedded within the unit time C. When the total count value TotalCounter is not equal to or higher than the number N, the process proceeds to step S25, where a shortage number N′ is obtained as N−TotalCounter. In step S26, the variable interval Interval is obtained as OrdCounter/N′.

When step S26 is ended or when it is determined in step S24 that the total count value TotalCounter is equal to or higher than the number N, the process proceeds to step S27 in FIG. 11 to return to the first packet in the unit time C.

Next, the total insertion count TotalInsert as a variable is set to zero in step S28. Then the insertion count value InsertCounter as a variable is set to zero in step S29. That is, the total insertion count TotalInsert and the insertion count value InsertCounter are initialized.

In step S30, the packet interval (T) is obtained. In step S31, the obtained packet interval T is set as the variable Tmp. In step S32, the CPU functions as the comparator 65 to determine whether Tmp−MIN is greater than MIN already detected by functioning in advance as the packet interval detecting unit 63. That is, in steps S30 to S32, the comparator 65 compares the packet interval T of each TS packet within the unit time C with the minimum value MIN detected by the packet interval detecting unit 63.

The CPU functions as the interval controlling unit 66. When it is determined in step S32 that Tmp−MIN is greater than MIN, the process proceeds to step S33, where the insertion count value InsertCounter as a variable is incremented because one packet Dn can be embedded. In step S34, Tmp−MIN is set as the variable Tmp. The process returns to step S32.

When it is determined in step S32 that Tmp−MIN is not greater than MIN, the process proceeds to step S35 to determine whether the insertion count value InsertCounter is greater than zero. When it is determined that the insertion count value InsertCounter is greater than zero, the process proceeds to step S38, where a variable TotalInsert+InsertCounter is set as Tmp2. Thereby a total number of packets Dn that can be embedded is obtained.

When it is determined in step S35 that the insertion count value InsertCounter is not greater than zero, whether the pointer is at a start of the interval Interval obtained in step S26 is determined in step S36. When the pointer is at the start of the interval Interval, the insertion count value InsertCounter is set to one. The process proceeds to step S38.

After TotalInsert+InsertCounter is set as Tmp2 in step S38, whether the variable Tmp2 is greater than the number N is determined in step S39. When the variable Tmp2 is greater than the number N, the process proceeds to step S40, where Tmp2−N is subtracted from the insertion count value InsertCounter.

Next, packets Dn the number of which is indicated by the insertion count value InsertCounter are inserted in step S41. In step S42, the insertion count value InsertCounter is added to the total insertion count TotalInsert. In step S43, whether the total insertion count TotalInsert=N is determined. When the total insertion count TotalInsert=N, the pointer is advanced to a start of a next unit time C. When it is determined in step S43 that the total insertion count TotalInsert≠N, the process returns to step S29 to repeat the process from step S29 to step S42.

Thus, the partial TS signal editor 1 embeds packets Dn in packet intervals greater than the minimum value MIN within a unit time C. When after the embedding of the packets, there remain packets Dn that cannot be embedded, the partial TS signal editor 1 calculates the interval Interval by dividing the ordinal count value OrdCounter by the shortage number N′, and embeds the packets Dn equal in number to the shortage number N′ in the interval Interval.

Thus, as described above, when the minimum packet interval MIN is one second and packet intervals within the unit time C are one second, two seconds, one second, and four seconds in this order, for example, a packet is embedded in the intervals of two seconds and four seconds, and intervals after the embedding of the packets is set not less than the minimum packet interval MIN. When packets embedded in the longer intervals are short in number, packets are inserted into interval parts having smaller differences from the minimum packet interval MIN. In this case, the intervals are rewritten as values obtained by dividing the original intervals into two equal parts in order to avoid an abrupt change in a bit rate. For example, when a packet is embedded in a one-second part, intervals after the embedding of the packet can be set to 0.5 seconds. That is, a DSD signal can be embedded evenly within the unit time C. New partial TS packets P2 thus generated are transmitted to the digital video-audio player 4.

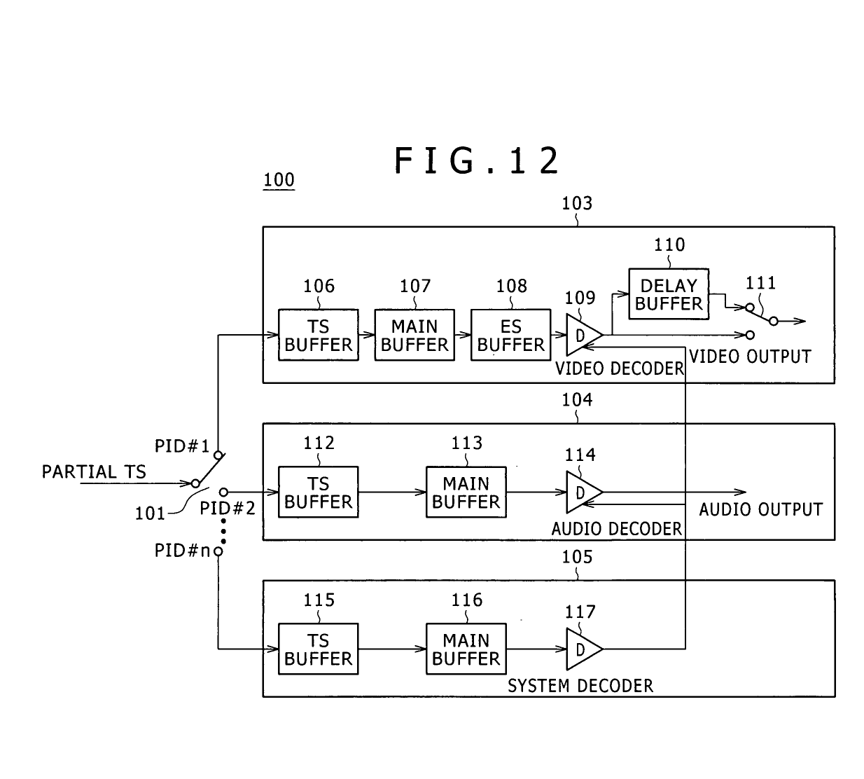

FIG. 12 shows a configuration of a decoder 100 reproducing a new partial TS signal P2 as above-described multiplexed data, the decoder 100 being present within the digital video-audio player 4. The new partial TS signal P2 supplied to an input terminal 101 results from time division multiplexing of transport packets for each decoding device. The partial TS signal P2 is switched by a selector switch 101 according to PIDs (Packet IDs) as content identifying information of header information. The partial TS signal P2 is thereby sent to the respective corresponding TS buffers 106, 112, and 115 of a video decoder unit 103, a one-bit audio signal decoder unit 104, . . . and another decoder unit 105.

The TS buffer 106 of the video decoder unit 103, the TS buffer 112 of the one-bit audio signal decoder unit 104, and the TS buffer 115 of the other decoder unit 105 each have a capacity of 512 bytes, for example. Video data, DSD audio data, and other data buffered in the TS buffers 106, 112, and 115 each having the capacity of 512 bytes are buffered in main buffers 107, 113, and 116 as system target decoder (STD) buffers.

The video data buffered in the main buffer 107 is sent to a video decoder 109 via an ES (Elementary Stream) buffer 108. The data read from the audio main buffer 113 is sent to an audio decoder 114. The data read from the other main buffer 116 is sent to a system decoder 117.

The video data is decoded according to decoded data on system control from the system decoder 117. At this time, when the decoded data is a so-called I-picture (intra-frame coded picture) or a P-picture (forward direction predictive coded picture), the video data is sent to one selected terminal of a selector switch 111 via a delay buffer 110. When the decoded data is a B-picture (bidirectionally predictive coded picture), the video data is sent to another selected terminal of the selector switch 111. An output from the selector switch 111 is extracted as video output.

The audio decoder 114 decodes the DSD data according to the decoded data on system control from the system decoder 117. The audio decoder 114 outputs the decoded DSD data as audio output.

As described above, when the partial TS signal editor 1 according to the first embodiment converts an analog audio signal into a delta sigma modulated one-bit audio signal, and multiplexes the one-bit audio signal and an HD video signal for transmission to a decoder side, with the video signal having a variable bit rate, time information (packet interval time information) in multiplexing is changed, whereby the high-quality one-bit audio signal and the HD video signal can be multiplexed. In particular, the partial TS signal editor 1 on a transmitting side in the multiplexed data transmission and reception system can evenly embed a DSD signal within a unit time C. Therefore, the DSD signal within newly generated partial TS packets after being transmitted to the digital video-audio player is reproduced with high sound quality without interruption as one-bit audio signal accompanying video of high image quality which video is based on the HD video signal.

A second embodiment of a partial TS signal editor will next be described. The second embodiment is a partial TS signal editor as a concrete example of a multiplexing device that multiplexes a partial TS signal including an HD-quality video signal and a DST signal obtained by DST compression of a 2-ch (stereo) one-bit audio signal.

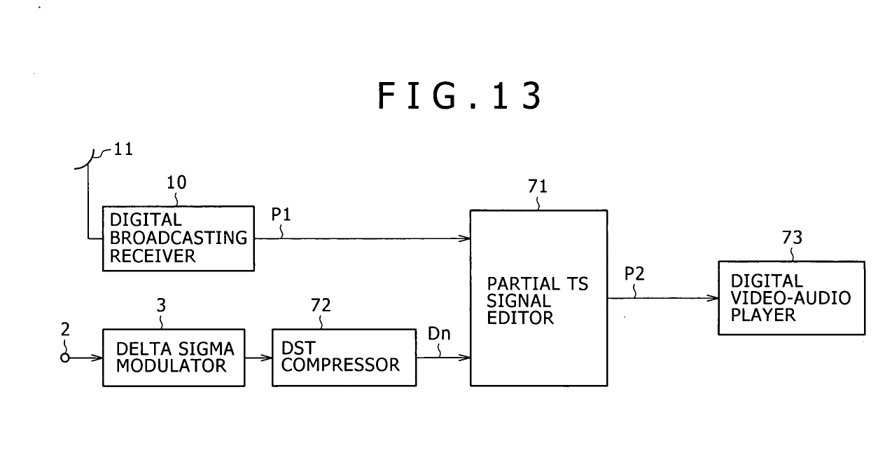

FIG. 13 shows a multiplexed data transmission and reception system including the partial TS signal editor 71 according to the second embodiment and a digital video-audio player 73 that receives multiplexed data as edit output transmitted from the partial TS signal editor 71 and reproduces an HD video signal and a DST signal generated by DST compression of a one-bit audio signal.

The partial TS signal editor 71 multiplexes a partial TS signal P1 from a digital broadcasting receiver 10 and a DST signal from a DST compressor 72, and thereby generates a new partial TS signal P2. The partial TS signal editor 71 transmits the partial TS signal P2 to the digital video-audio player 73.

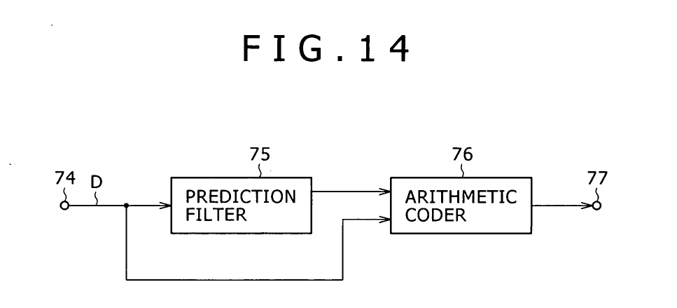

The DST compressor 72 compresses the DST signal (one-bit audio signal) on the basis of lossless coding (lossless compression) techniques (above-mentioned Patent Document 1). Specifically, as shown in FIG. 14, the DST compressor 72 includes a prediction filter 75 based on principles of predictive coding and an arithmetic coder 76. A difference between an input signal from an input terminal 74 and a prediction value is obtained within the prediction filter 75. The arithmetic coder 76 codes the difference together with a distribution deviation, that is, a distribution probability. The coded output is supplied as a DST signal from an output terminal 77 to the partial TS signal editor 71. Since the distribution probability of a difference is determined by a rate of coincidence of prediction within the prediction filter, the more often the prediction coincides, the higher the probability that can be given to the difference becomes. Then, a difference in an interval is subjected to arithmetic coding within the arithmetic coder using the distribution probability of the difference in the interval, whereby the difference in the interval becomes a compressed code.

As is understood with reference to FIG. 12, the digital video-audio player 73 has an audio decoder within the digital video-audio player 73. In this example, the decoder has a DST decompression function corresponding to the DST compressor 72.

As in the partial TS signal editor 1 according to the first embodiment, a CPU in the partial TS signal editor 71 functions as functional blocks as shown in FIG. 7 to embed TS packets Dn including the DST signal in the partial TS signal P1 and thereby generate a new partial TS signal P2 as described with reference to FIG. 6, FIG. 8, FIGS. 9A to 9D, and FIG. 10, and FIG. 11.

Further, whereas a DSD signal has a fixed bit rate, the DST signal has a variable rate. Thus, transmission intervals of TS packets to be embedded can be adjusted on principles to be described in the following.

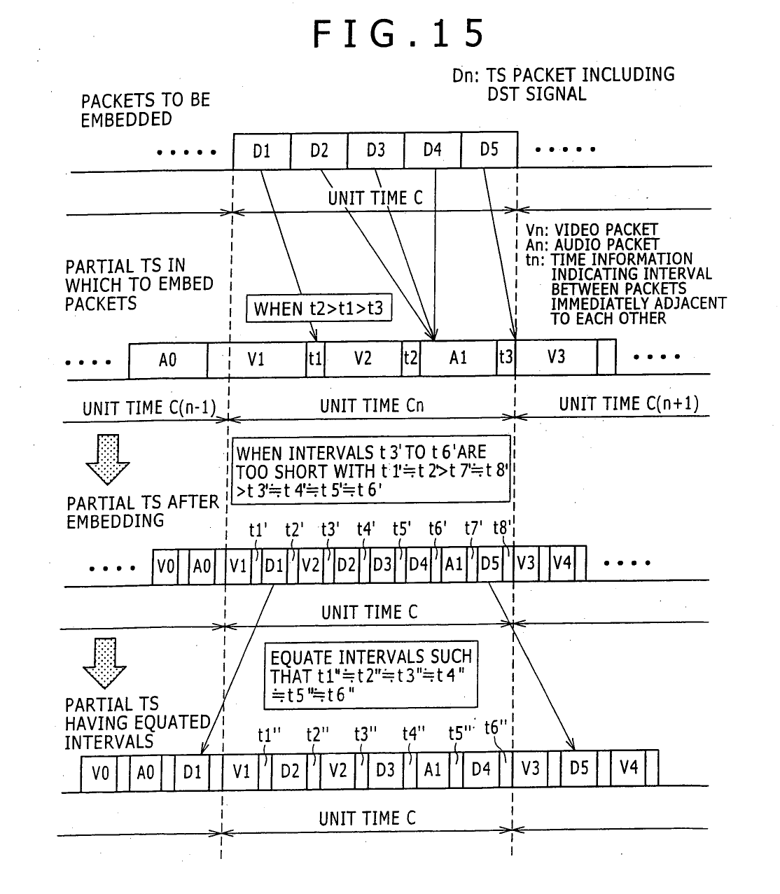

FIG. 15 is a conceptual diagram of a distributing process at a time of embedding packets in the partial TS signal editor according to the second embodiment. The conceptual diagram is used to describe a method of adjusting transmission intervals of TS packets to be embedded when the intervals are reduced by embedding the packets, and thereby a bit rate is increased locally, so that an overflow may occur in a buffer used by a decoder on a receiving side.

When transmitting multiplexed data after embedding packets including the signal obtained by compressing the one-bit audio signal between a plurality of packets including the video signal, an interval controlling unit 66 controls an embedding unit 68 so as to adjust a transfer rate on the basis of the buffer capacity of the decoding device on the receiving side. The interval controlling unit 66 thereby prevents a failure of the buffer of the decoding device on the receiving side.

Specifically, the interval controlling unit 66 controls the embedding unit 68 so as to embed in a preceding or succeeding unit time at least one of the plurality of packets including the signal obtained by compressing the one-bit audio signal which packets are to be embedded between a plurality of packets including the video signal within a present unit time. The interval controlling unit 66 thereby prevents a failure of the buffer of the decoder on the receiving side.

Suppose that TS packets to be embedded are D1, D2, D3, D4, D5, . . . including a DST signal, for example. Suppose that the packet interval time information of a video packet V1, a video packet V2, and an audio packet A1 within a unit time Cn of a partial TS in which to embed the TS packets is t1, t2, and t3, respectively, and that t2>t1>t3. The packet interval time information t1 is information on a time from a start of transmission of the video packet V1 to a start of transmission of the next video packet V2. Similarly, the packet interval time information t2 is information on a time from the start of transmission of the video packet V2 to a start of transmission of the next audio packet A1. The packet interval time information t3 is information on a time from the start of transmission of the audio packet A1 to a start of transmission of a first video packet V3 within a next unit time C(n+1).

In this case, since the packet interval time information t2 represents a long time interval, many of the TS packets Dn including the DST signal are embedded in a t2 part (immediately after the packet V2). In this case, three packets Dn, that is, the packets D2, D3, and D4 are embedded.

The packet D2 is embedded so as to start to be transmitted at a packet interval t′3 from the start of transmission of the video packet V2. The packet D3 is embedded so as to start to be transmitted at a packet interval t′4 from the start of transmission of the packet D2. The packet D4 is embedded so as to start to be transmitted at a packet interval t′5 from the start of transmission of the packet D3. A packet interval between the packet D4 and the audio packet A1 is set at t′6.

Thus, after the embedding of the three packets Dn, that is, the packets D2, D3, and D4, t2 is divided into t′3, t′4, t′5, and t′6. Of course, t2=t′3+t′4+t′5+t′6. When t′3, t′4, t′5, and t′6 are small values, the packets D2, D3, and D4 are transmitted at a high bit rate, and thus the bit rate may exceed a transfer rate allowed by the capacity of a buffer in the decoder of the receiver (digital video-audio player). This results in an overflow of the buffer of the decoder. When the decoder overflows, the receiver cannot reproduce the packets Dn.

Accordingly, on the basis of the buffer capacity of the decoder, in a case where the buffer may overflow, the partial TS signal editor 71 allocates a few packets (packets D1 and D5 in FIG. 15) at a start and an end among the TS packets to be embedded within the unit time Cn to an immediately preceding unit time C(n−1) and an immediately succeeding unit time C(n+1).

Information on the buffer capacity of the decoder can be set to be notified from the receiving side to the partial TS signal editor 71 as a transmitting side automatically in advance at a time of connection in the multiplexed data transmission and reception system. Alternatively, the information may be input by a user.

Thus, the multiplexed data transmission and reception system using the partial TS signal editor 71 can prevent the increase in the bit rate due to the reduction of embedding intervals in the unit time Cn. It is therefore possible to prevent an overflow of the buffer of the decoder on the receiver side, and thus prevent a failure of the receiver to reproduce the packets Dn.

The DST signal included in the packets Dn in this example has a variable rate, as described above. Hence, even when multiplexing timing is slightly shifted by performing multiplexing so as to transmit the packets D1 and D5, which are normally to be transmitted in the unit time Cn, in the preceding unit time C(n−1) and the succeeding unit time C(n+1), reproduction can be performed without any problem as long as the shift does not cause the buffer to overflow or underflow.

As described above, when the partial TS signal editor 71 according to the second embodiment converts an analog audio signal into a delta sigma modulated one-bit audio signal, and multiplexes a DST signal obtained by further subjecting the one-bit audio signal to DST compression and an HD video signal for transmission to a decoder side, with the video signal having a variable bit rate, time information (packet interval time information) in multiplexing is changed, whereby the high-quality one-bit audio signal and the HD video signal can be multiplexed. In particular, the partial TS signal editor 71 on a transmitting side in the multiplexed data transmission and reception system can evenly embed the DST signal within a unit time C. Therefore, the DST signal within newly generated partial TS packets after being transmitted to the digital video-audio player is reproduced with high sound quality without interruption as one-bit audio signal accompanying video of high image quality which video is based on the HD video signal.

In addition, the partial TS signal editor 71 according to the second embodiment embeds the packets including the DST signal having a variable rate which signal is generated by compressing the one-bit audio signal by compression techniques in a partial TS signal including the HD video signal. The partial TS signal editor 71 can adjust the transmission intervals of the TS packets to be embedded when the intervals are reduced by embedding the packets and thereby the bit rate is increased locally, so that an overflow may occur in the buffer used by the decoder on the receiving side. Thus, the partial TS signal editor 71 can prevent the increase in the bit rate due to the reduction of embedding intervals in the unit time Cn. It is therefore possible to prevent an overflow of the buffer of the decoder on the receiver side forming the multiplexed data transmission and reception system, and thus prevent a failure of the receiver to reproduce the packets Dn.

A multiplexing device and a multiplexing method according to an embodiment of the present invention relate to the inside of a system that multiplexes packets including a one-bit audio signal obtained by subjecting an analog audio signal to delta sigma modulation between a plurality of packets including a video signal. When the video signal has a variable bit rate, the multiplexing device and the multiplexing method change time information in multiplexing, thereby making it possible to multiplex the packets including the one-bit audio signal. In addition, the multiplexing device and the multiplexing method also make it possible to multiplex packets including a signal generated by compressing a one-bit audio signal between a plurality of packets including a video signal having a variable bit rate.

A multiplexing device on a transmitting side in a multiplexed data transmission and reception system according to an embodiment of the present invention can evenly embed a DSD signal within a unit time. The DSD signal within new multiplexed data generated by the multiplexing device is transmitted to a decoding device such for example as a digital video-audio player, and is then reproduced with high sound quality without interruption as one-bit audio signal accompanying video of high image quality which video is based on an HD video signal.

In addition, when packets including a DST signal having a variable rate which signal is generated by compressing a one-bit audio signal by compression techniques are embedded in a partial TS signal including an HD video signal, an increase in a bit rate due to the reduction of embedding intervals in a unit time Cn can be prevented. It is therefore possible to prevent an overflow of the buffer of a decoding device on a receiver side forming the multiplexed data transmission and reception system, and thus prevent a failure of the receiver to reproduce the packets Dn.

The multiplexing of a video signal having a variable bit rate and a digital signal which multiplexing is performed by the multiplexing device and the multiplexing method according to the embodiment of the present invention is essential in a field of multimedia data transmission. Also, development of one-bit audio signals is expected in MPEG standards.

It is to be noted that while the foregoing embodiments use a 2-ch one-bit audio signal, the foregoing embodiments can deal with a multichannel one-bit audio signal.

It is desirable to provide a multiplexing device that can multiplex a one-bit audio signal having a fixed bit rate or a signal obtained by compressing a one-bit audio signal by compression techniques.

The packet interval detecting unit 63 detects a minimum packet interval MIN of an original partial TS signal P1, and supplies the minimum packet interval MIN to the comparator 65. The comparator 65 notifies the interval controlling unit 66 of detection information indicating which of pieces of packet interval time information of the original partial TS signal are greater than the minimum packet interval time information MIN. The interval controlling unit 66 supplies the embedding unit 68 with an embedding control signal to embed a packet D in a greater interval on the basis of the detection information supplied from the comparator 65 and equate TS packet intervals. The embedding unit 68 embeds packets Dn including a one-bit audio signal in the original partial TS signal P1 on the basis of the embedding control signal supplied from the interval controlling unit 66.

It should be understood by those skilled in the art that various modifications, combinations, sub-combinations and alterations may occur depending on design requirements and other factors insofar as they are within the scope of the appended claims or the equivalents thereof.

What is claimed is:

1. A multiplexing device wherein a packet including a one-bit audio signal obtained by subjecting an analog audio signal to a delta sigma modulation process is multiplexed between a plurality of packets including a video signal having a variable bit rate by changing packet interval time information between the plurality of packets including the video signal having said variable bit rate.

2. The multiplexing device as claimed in claim 1,
wherein said packet is a packet including a signal obtained by compressing the one-bit audio signal obtained by subjecting said analog audio signal to the delta sigma modulation process.

3. A multiplexing device for multiplexing audio data between video signal packets to be transmitted, said multiplexing device comprising:
interval controlling means for referring to packet interval time information between a plurality of packets including a video signal having a variable bit rate, and performing control to embed a packet including a one-bit audio signal obtained by subjecting an analog audio signal to a delta sigma modulation process in a packet interval selected with a predetermined time interval as a reference;
embedding means for embedding the packet including said one-bit audio signal between a plurality of packets including said video signal under control of said interval controlling means; and
rewriting means for rewriting packet interval time information after said embedding means embeds said packet between the plurality of packets including said video signal.

4. The multiplexing device as claimed in claim 3, further comprising comparing means for comparing the packet interval time information between the plurality of packets including the video signal having said variable bit rate with minimum packet interval time information,
wherein said interval controlling means performs control to embed the packet including said one-bit audio signal in said packet interval greater than said minimum packet interval time information on a basis of a comparison result from said comparing means.

5. The multiplexing device as claimed in claim 3,
wherein said embedding means embeds said packet according to a number of packets including said one-bit audio signal to be embedded between a plurality of packets including said video signal within a unit time.

6. The multiplexing device as claimed in claim 3,
wherein when n packets including said one-bit audio signal are to be embedded at a time of transmitting one packet including said video signal in arbitrary packet interval time information TL, said interval controlling means sets a time TW1 to a start of transmission of a first packet of the n packets not less than a time TT for transmitting one packet including said video signal and not more than TL/(n+1) obtained by dividing the arbitrary packet interval time information TL by (n+1).

7. The multiplexing device as claimed in claim 3,
wherein said packet is a packet including a signal obtained by compressing the one-bit audio signal obtained by subjecting said analog audio signal to the delta sigma modulation process.

8. A multiplexed data transmission and reception system in which a video signal to be transmitted and an audio signal are multiplexed and transmitted, said multiplexed data transmission and reception system comprising:
a multiplexing device for multiplexing a packet including a one-bit audio signal obtained by subjecting an analog audio signal to a delta sigma modulation process between a plurality of packets including a video signal having a variable bit rate by changing packet interval time information between the plurality of packets including the video signal having the variable bit rate; and
a decoding device for receiving multiplexed data from said multiplexing device, and decoding the multiplexed data using a buffer memory.

9. The multiplexed data transmission and reception system as claimed in claim 8,
wherein said multiplexing device includes:
interval controlling means for referring to packet interval time information between a plurality of packets including the video signal having the variable bit rate, and performing control to embed the packet including the one-bit audio signal obtained by subjecting the analog audio signal to the delta sigma modulation process in a packet interval selected with a predetermined time interval as a reference;
embedding means for embedding the packet including said one-bit audio signal between the plurality of packets including said video signal under control of said interval controlling means; and
rewriting means for rewriting packet interval time information after said embedding means embeds said packet between the plurality of packets including said video signal.

10. The multiplexed data transmission and reception system as claimed in claim 8,
wherein said multiplexing device further includes comparing means for comparing the packet interval time information between the plurality of packets including the video signal having said variable bit rate with minimum packet interval time information, and
said interval controlling means performs control to embed the packet including said one-bit audio signal in said packet interval greater than said minimum packet interval time information on a basis of a comparison result from said comparing means.

11. The multiplexed data transmission and reception system as claimed in claim 8,
wherein said packet is a packet including a signal obtained by compressing the one-bit audio signal obtained by subjecting said analog audio signal to the delta sigma modulation process.

12. A multiplexing device for multiplexing audio data between video signal packets to be transmitted, said multiplexing device comprising:
an interval controller referring to packet interval time information between a plurality of packets including a video signal having a variable bit rate, and performing control to embed a packet including a one-bit audio signal obtained by subjecting an analog audio signal to a delta sigma modulation process in a packet interval selected with a predetermined time interval as a reference;
an embedding section embedding the packet including said one-bit audio signal between a plurality of packets including said video signal under control of said interval controller; and
a rewriter rewriting packet interval time information after said embedding section embeds said packet between the plurality of packets including said video signal.
